(19) United States
(12) Patent Application Publication
(10) Pub. No.: US 2002/0001703 A1
(43) Pub. Date: Jan. 3, 2002

(54) Lightweight fiber-reinforced thermoplastic resin molding

(75) Inventor: Satoru Funakoshi, Kameoka-shi (JP)

Correspondence Address: FITCH EVEN TABIN AND FLANNERY, 120 SOUTH LA SALLE STREET, SUITE 1600, CHICAGO, IL, 606033406

(73) Assignee: Sumitomo Chemical Company, Limited, Osaka (JP)

(21) Appl. No.: 09/891,168

(22) Filed: Jun. 26, 2001

(30) Foreign Application Priority Data
Jun. 28, 2000 (JP) 2000-194269

(51) Int. Cl. B32B 13/02

(52) U.S. Cl. 428/294.7

(57) ABSTRACT

The present invention provides a lightweight fiber-reinforced thermoplastic resin molding comprising a thermoplastic resin and having a skin layer and a beam-supported structure layer, the thermoplastic resin containing reinforcing fibers whose average fiber length is maintained at 1 mm or more, the skin layer having almost no voids, the beam-supported structure layer containing reinforcing fibers which are intertwined complicatedly with each other and are fixed to each other with the thermoplastic resin in the vicinity of their contacts, wherein the beams forming the beam-supported structure layer are arcuate as an aggregate in the plane direction of the molding, said a lightweight fiber-reinforced thermoplastic resin molding having a high percentage of void and is lightweight and excellent in bending rigidity.

### BACKGROUND OF THE INVENTION

1. Field of the Invention

The present invention relates to lightweight fiber-reinforced thermoplastic resin moldings having a skin layer and a beam-supported structure layer.

2. Description of the Related Art

As moldings that are reinforced with reinforcing fibers and have voids formed therein, lightweight fiber-reinforced thermoplastic resin moldings which have a dense skin layer having almost no voids and a core layer having voids are well known. Such generally known lightweight fiber-reinforced thermoplastic resin moldings do not necessarily have satisfactory bending rigidities at high expansion ratios. Furthermore, for example, JP-A-7-16933 discloses a fiber-reinforced thermoplastic resin molding comprising a fiber-reinforced thermoplastic resin containing 20-70% by weight of reinforcing fibers 5-25 mm long, the molding having a foamed core layer and skin layers disposed on both surfaces of the core layer, the skin layers containing reinforcing fibers oriented almost in parallel to their surfaces, wherein 20% by weight or more of the reinforcing fibers contained in the core layer are oriented almost perpendicular to the skin layers.

However, in such a fiber-reinforced thermoplastic resin molding, reinforcing fibers have no beam-supported structure forming aggregates and exist in the form of many independent beams and many of the reinforcing fibers in the core layer are oriented almost perpendicular to the skin layers. Therefore, there also is a problem that when the moldings are of high foaming or expansion ratios, resistance of their surfaces to slippage is reduced, and as a result, the moldings become poor in bending rigidity.

In view of these facts, the inventors of the present invention studied to develop lightweight fiber-reinforced thermoplastic resin moldings that have high bending rigidities even if they have high foaming or expansion ratios, and as a result, the inventors have reached the present invention.

Accordingly, the present invention provides a lightweight fiber-reinforced thermoplastic resin molding comprising a thermoplastic resin and having a skin layer and a beam-supported structure layer, the thermoplastic resin containing reinforcing fibers whose average fiber length is maintained at 1 mm or more, the skin layer having almost no voids, the beam-supported structure layer containing reinforcing fibers which are intertwined complicatedly with each other and are fixed to each other with the thermoplastic resin in the vicinity of their contacts, wherein the beams forming the beam-supported structure layer are arcuate as an aggregate in the plane direction of the molding.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step.

### BRIEF DESCRIPTION OF THE DRAWINGS

FIG. 1 includes sectional schematic views of lightweight fiber-reinforced thermoplastic resin moldings of the present invention, FIG. 1(a) showing the case where there is no skin material on the surface and FIG. 1(b) showing the case where a skin material is laminated;

FIG. 2 includes schematic views illustrating four examples of states where aggregates of beams are formed in an arcuate form in the beam-supported structure layer of a lightweight fiber-reinforced thermoplastic resin molding of the present invention;

FIG. 3 is a schematic sectional view of a mold to be used for the production of a lightweight fiber-reinforced thermoplastic resin molding of the present invention; and

FIG. 4 illustrates a process for the production of a lightweight fiber-reinforced thermoplastic resin molding of the present invention by a schematic sectional view of a mold.

FIG. 5 illustrates a process for the production of a lightweight fiber-reinforced thermoplastic resin molding of the present invention by a schematic sectional view of a mold.

FIG. 6 illustrates a process for the production of a lightweight fiber-reinforced thermoplastic resin molding of the present invention by a schematic sectional view of a mold.

FIG. 7 illustrates a process for the production of a lightweight fiber-reinforced thermoplastic resin molding of the present invention by a schematic sectional view of a mold.

FIG. 8 illustrates a process for the production of a lightweight fiber-reinforced thermoplastic resin molding of the present invention by a schematic sectional view of a mold.

FIG. 9 illustrates a process for the production of a lightweight fiber-reinforced thermoplastic resin molding of the present invention by a schematic sectional view of a mold.

FIG. 10 illustrates a process for the production of a lightweight fiber-reinforced thermoplastic resin molding of the present invention by a schematic sectional view of a mold.

FIG. 11 illustrates a process for the production of a lightweight fiber-reinforced thermoplastic resin molding of the present invention by a schematic sectional view of a mold.

FIG. 12 illustrates a process for the production of a lightweight fiber-reinforced thermoplastic resin molding of the present invention by a schematic sectional view of a mold.

### DETAILED DESCRIPTION OF THE PREFERRED EMBODIMENTS

There will be made a description on the present invention below.

The following are examples of the present invention and the invention is not limited thereto.

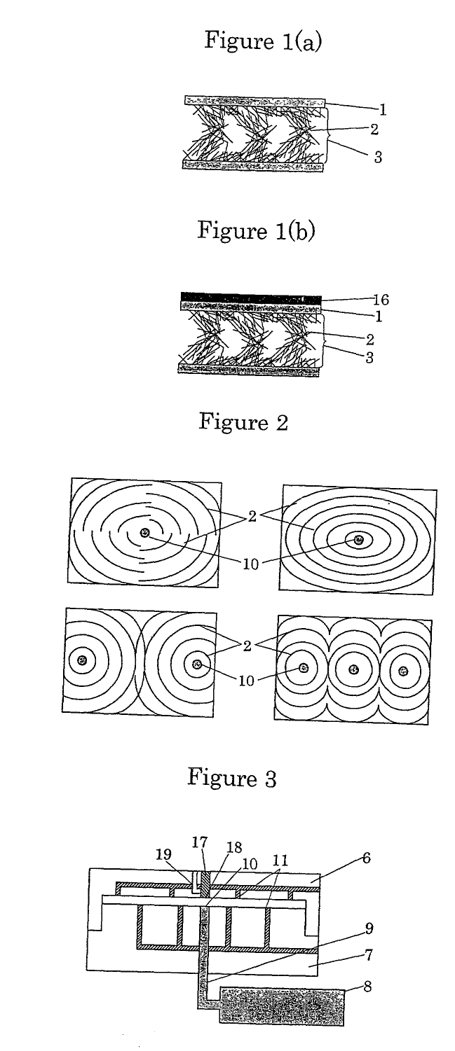

The lightweight fiber-reinforced thermoplastic resin molding of the present invention comprises a skin layer (1) having almost no voids and a beam-supported structure layer (3) in which the reinforcing fibers are intertwined complicatedly with each other and the fibers are fixed to each other with the thermoplastic resin in the vicinity of their contacts, as its section is shown in FIG. 1 (FIG. 1(a)).

Moreover, the molding may have a structure where a skin material (16) is disposed on the skin layer (1), as needed (FIG. 1(b)).

In such moldings, the beam-supported structure layer (3) has a structure in which reinforcing fibers to form beams are aggregated and the aggregates (2) of the beams form arcuate forms in view of the plane direction of the molding.

Such moldings are required to use a thermoplastic resin containing reinforcing fibers whose average fiber length is maintained at 1 mm or more. In the case of reinforcing fibers having an average fiber length less than 1 mm, sufficient bending rigidity cannot be obtained.

Furthermore, if the content of the reinforcing fibers in the thermoplastic resin is properly great, a good bending rigidity can be obtained. The content of the reinforcing fibers in the thermoplastic resin is usually about 10-80% by weight, and preferably about 20-50% by weight with respect to the thermoplastic resin.

As the reinforcing fibers to be used, various conventionally known reinforcing fibers such as glass fibers, carbon fibers and alumina fibers may be applied. Glass fibers are widely used as the most popular one.

As the thermoplastic resin to be used, any resin may be applied as long as it can be used in extrusion forming, injection molding, press molding and the like. For example, general thermoplastic resins such as polyethylenes, polypropylenes, polystyrenes, acrylonitrile-styrene-butadiene copolymers, polyvinyl chlorides, polyamides, polycarbonates and polyethylene terephthalates, mixtures thereof, or polymer alloys using these thermoplastic resins may be mentioned. The term “thermoplastic resin” used in the present invention includes all of these species.

Moreover, such thermoplastic resin may, as needed, contain fillers such as talc. Various additives conventionally used, such as pigments, lubricants, antistatic agents and stabilizers, may optionally be incorporated.

In such reinforcing fibers and thermoplastic resins, the greater the adhesion of the reinforcing fibers to the thermoplastic resin, the firmer the linkage of the fibers themselves through the matrix resin and the strength of expanded moldings is also improved. Therefore, in the case, for example, of the combination: the matrix resin is a polypropylene-based resin and the reinforcing fibers are glass fibers it is effective to improve the adhesion by applying surface treatment to the glass fibers or incorporating a modifier to the polypropylene-based resin.

The molding comprising these materials has, for example, a laminated structure in which skin layers (1) are formed on both surfaces of a beam-supported structure layer (3), which is a core layer.

The skin layers (1) located in both surfaces of the molding are superior in tensile strength with respect to the plane direction of the molding and contribute to the enhancement of bending rigidity of the molding. The central beam-supported structure layer (3) plays a role in reducing the weight of the whole molding and in ensuring the thickness of the molding.

Furthermore, the average percentage of void of the whole molding having the skin layers and the beam-supported structure layer is preferably 50 vol % or more, and more preferably 60 vol % or more with respect to the purpose of weight reduction. The present invention is effective for moldings having higher percentages of void.

The following are explanations on each layer.

A skin layer (1) is located in a surface of a molding, and may be provided in only one of both surfaces of the molding but is preferably provided in both surfaces of the molding in order to enhance the bending rigidity.

The thickness of the skin layer has a great effect on weight reduction of the molding. In general, as the skin layer becomes thicker, the strength of the molding is improved but the weight increases. To make the skin layer thinner is effective for weight reduction of the molding but the skin layer becomes easier to break and the strength of the molding is deteriorated.

This is because the skin layer located outermost is applied with tensile stress or compression stress in the plane direction of the molding when the molding is applied with bending load, and the skin layer is easy to break due to the tensile stress or to be buckled due to the compression stress.

For this end, it is preferable that a ratio of the amount of the resin occupied by the skin layer to the amount of the resin contained in the whole molding is about 5-30% by weight and the thickness of the skin layer is about 0.1-2 mm.

The material to constitute such a skin layer is required to have a high tensile strength. For this end, it is necessary for the skin layer to contain reinforcing fibers having an average fiber length of 1 mm or more and to have approximately no voids or only slight voids therein. Here, the condition means “almost no voids”.

Generally, when a thermoplastic resin contains reinforcing fibers, its strength can be improved greatly, and in particular, to contain reinforcing fibers has great effects on the improvement of tensile strength or bending strength. Such strength tends to become greater as the reinforcing fibers become longer.

For this reason, by causing a skin layer to contain reinforcing fibers whose average fiber length is 1 mm or more, a skin layer superior in strength can be formed.

Furthermore, since generally there is a tendency that when a volume proportion of voids (percentage of void) in a thermoplastic resin becomes higher, the strength of the thermoplastic resin is deteriorated, it becomes necessary to reduce a percentage of void in the skin layer so that there may be approximately no voids or only slight voids in the skin layer for the purpose of preventing buckling due to compression stress.

Moreover, it is preferable for the reinforcing fibers in the skin layer to be oriented approximately in parallel to the plane of the molding for preventing breakage or buckling of the skin layer.

The orientation of the reinforcing fibers with respect to the plane direction of the molding is not particularly limited and may be optionally determined according to bending rigidity, etc. required for a desired molding. However, for example, if particularly high rigidity is required in a single direction, it is preferable that many of the reinforcing fibers are oriented in this direction. If rigidity is not required to be directional, the reinforcing fibers are preferably oriented at random.

The beam-supported structure layer (3), in which the reinforcing fibers are intertwined complicatedly with each other and the fibers are fixed to each other with the thermoplastic resin in the vicinity of their contacts, increases the thickness of the whole molding and plays a role of the rigidity improvement caused by the thickness effect.

It is desirable that such a beam-supported structure layer (3) has a high percentage of void for weight reduction of the molding. In usual, the percentage of void of the beam-supported structure layer is about 50-90 vol %.

In the beam-supported structure layer (3), as shown in FIG. 2 by schematic views of planar outline of four typical examples of the beam-supported structure layer, each beam-supported structure is required to form an arcuate form in the plane direction of the molding as aggregates (2) of beams comprising aggregated reinforcing fibers.

Although the beam-supported structure is superior in strength even if it is formed from isolated reinforcing fibers, improved strength can be achieved by forming aggregates comprising reinforcing fibers which are intertwined complicatedly with each other.

Here, by the “aggregates (2) of beams” is meant aggregates of reinforcing fibers in which beam-supported structures are stretched linearly in view of the plane direction of the molding and each beam forms a beam continuous in the plane direction in which a plurality of reinforcing fibers are complicatedly tangled with other reinforcing fibers.

When the aggregates (2) of such continuous beams form an arcuate in view of the plane direction of the molding, the resistance of a skin layer to its slippage becomes greater, and as a result, it becomes possible to increase the bending rigidity of the molding.

Furthermore, beams are formed continuously, the beams give effect mutually, thereby achieving strength superior to that achieved by many isolated beams.

Here, the “arcuate form” of the aggregates (2) of the beams is not necessarily required to be perfectly arcuate and is only required to be arcuate as a rough configuration recognizable as an arc. It may be a configuration where a small arc is combined inside a large arc, and also may be an arc whose curvature varies locally. In some cases, arcs may be connected with or intersect each other. Furthermore, the arc may locally have a linear part. Moreover, an arc whose initial point and terminal point are the same, that is, a closed end form such as an almost arcuate form and an almost oval form is also acceptable.

The arc is not required to be single but may be doubled or tripled so that a plurality of arcs are formed in positions mutually adjacent. The arc may also be a spiral form. Furthermore, a plurality of arcs may be formed adjacently.

The length or width of the arc may be determined optionally depending upon the size or thickness of a molding desired.

It is desirable that the reinforcing fibers constituting the beam-supported structure layer are oriented with leaning to the thickness direction of the molding and most of them, generally about 50% or more of the reinforcing fibers, make angles of 10-70 degrees to the skin layer.

By such angled orientation of the reinforcing fibers, the resistance of the skin layer to its slippage is further enhanced.

It is important for the reinforcing fibers constituting such a beam-supported structure layer to have an average fiber length of 1 mm or more. If the average fiber length is less than 1 mm, reinforcing fibers are not intertwined complicatedly with each other and the strength of the beam-supported structure layer (3) decreases, and particularly, resistance to compression in the thickness direction of the molding decreases, as a result, no beam-supported structure layer of good characteristics may be formed.

Furthermore, it is not necessary for the reinforcing fibers contained in the beam-supported structure layer to exist only in the beam-supported structure layer and also may be continuously located from the beam-supported structure layer to the skin layer.

Descriptions have been made above on the skin layer and the beam-supported structure layer, but these descriptions are not necessarily applied to the whole molding. For example, the skin layer or the beam-supported structure layer may exist partly or in plural parts of a molding. Thickness or percentage of void of each layer may be varies locally.

In some cases, a layer having about 10-50 vol % of voids may be integrally formed between the skin layer and the beam-supported structure layer.

Such a layer has an effect on preventing the skin layer from breakage due to tensile stress applied to the skin layer or buckling due to compression stress applied to the skin layer and can further improve the bending rigidity of the molding.

The thickness of such a layer may be selected and determined depending upon the thickness of a desired molding or bending rigidity required, but it is preferable that a proportion of the amount of resin occupied by this layer is about 10-60% by weight of the amount of resin of the whole molding with respect to the compatibility of weight reduction of a molding and bending rigidity.

Next, with reference to drawings, examples of a process for the production of such a lightweight fiber-reinforced thermoplastic resin molding are illustrated.

FIG. 3 illustrates the outline of an example of a mold to be used in this process by its cross sectional view.

This mold comprises a pair of a male die (7) and a female die (6), one of the dies being generally associated with a press device and being movable, another one being fixed, and the mold can be opened and closed vertically or horizontally. (In the drawing, the male die is fixed, the female die is movable, and the mold can be opened and closed vertically.) Although a method to supply a molten thermoplastic resin containing reinforcing fibers (henceforth, may be referred, simply, to as a molten resin) to a mold cavity is optional, a method is usually employed by choice in which a resin supply opening (10), which is connected to a resin supply device (8) via a resin supply passage (9) dug in the mold, is provided in the molding surface of one or both of the female and male dies (in FIG. 3, the opening is provided in the molding surface of the male die), and the molten resin is supplied to the cavity through the resin supply opening.

In this case, it is also possible to design the mold so that a freely-operatable valve is provided in the resin supply passage in the vicinity of the resin supply opening and the supply of a molten resin accumulated in the resin supply device such as an injection unit and the stop thereof can freely be controlled The mold may have a suction opening (11), which opens to the cavity, provided to a molding surface of one or both of the female and male dies, and may be designed so that an expanded molding is attracted onto the molding surface by evacuation through the opening.

The suction opening (11) is connected to an evacuating device, which is not shown, such as a vacuum pump via a suction path and the suction path may be equipped with a valve capable of freely controlling suction and its stop and also may be equipped with a controlling mechanism for adjusting suction force, as needed The suction opening (11) opens in a molding surface of the mold and also may be fine pores such that a molten resin cannot enter. Moreover, it may also be a crack in the juncture of parts constituting the mold, generally called the parting line. Alternatively, the mold may be constituted in part or in approximately whole of porous metal having gas permeability.

Moreover, the mold may have a structure where one or both of the female and male dies have a portion that interconnects the inside and the outside (the atmosphere) of the cavity and the air is introduced to the cavity through that portion.

The interconnecting portion may be an opening hole (18) formed in the molding surface of the mold and also may be a pin-like part (not shown) having an opening hole. Alternatively, the periphery portion of the mold cavity may be utilized as the interconnecting portion.

For example, in the case where an opening hole (18) is provided in the molding surface of the mold, the opening hole (18) is opened to the atmosphere via an air channel (19) provided in the mold. To the opening hole (18), a valve (17) for opening and closing the opening hole, which can freely control the opening and closure of the opening hole, may be provided. Moreover, a controlling mechanism for adjusting the opening area of the opening hole may also be provided, as need.

Using such a mold, a molten resin (12) is charged to between the female and male dies (FIG. 5). In the production of the molding of present invention, it is important to supply a molten thermoplastic resin containing reinforcing fibers whose average fiber length is maintained at 1 mm or more to a mold cavity.

By the “average fiber length of reinforcing fibers” used in the present invention is meant the length of the fibers contained in the thermoplastic resin of the molding obtained. Therefore, the “reinforcing fibers whose average length is maintained at 1 mm or more” means reinforcing fibers having length such that the reinforcing fibers in the thermoplastic resin of the molding obtained have an average length of 1 mm or more. As the “average fiber length”, a weight average fiber length, which is a general index, is used.

The “average fiber length of reinforcing fibers” used in the following description has the same meaning as that described above.

A method for supplying such a molten thermoplastic resin containing reinforcing fibers whose average fiber length is maintained at 1 mm or more to a mold cavity may be one comprising supplying a molten resin to a cavity wherein the molten resin is obtained by melt-kneading reinforcing fibers having an average fiber length of 3 mm or more and thermoplastic resin granules or pellets in, for example, an injection unit having an in-line screw, or one comprising supplying a molten resin to a cavity wherein the molten resin is obtained by melt-kneading a pre-formed thermoplastic resin material containing reinforcing fibers having an average fiber length of 3 mm or more, for example, long-fiber-reinforced thermoplastic resin pellets.

In the latter method, the preferably employed as the long-fiber-reinforced thermoplastic resin pellets is what is obtained by impregnating glass roving with a molten thermoplastic resin, cooling and solidifying the resultant, and then cutting it into proper length, for example, about 3-25 mm to form pellets. Such long-fiber-reinforced thermoplastic resin pellets may be used alone or after being admixed with resin pellets comprising the matrix resin of the long-fiber-reinforcing thermoplastic resin for the adjustment of reinforcing fiber content, and also may be used after being mixed with other thermoplastic resin pellets. Furthermore, they may contain a necessary amount of foaming agent.

The temperature of the molten resin to be used varies depending on the type of heat and molding conditions, and on the type of a skin material to be used when a skin material is used, and is set to an optimum temperature. For example, when a glass fiber-reinforced resin containing a polypropylene-based resin as a matrix is used, the temperature of the resin is about 170-300° C., preferably about 200-280° C.

The charge of the molten resin (12) to the mold cavity may be conducted by either injection charging or closing the female and male dies. The way of charging the molten resin may optionally be selected depending on the desired product form.

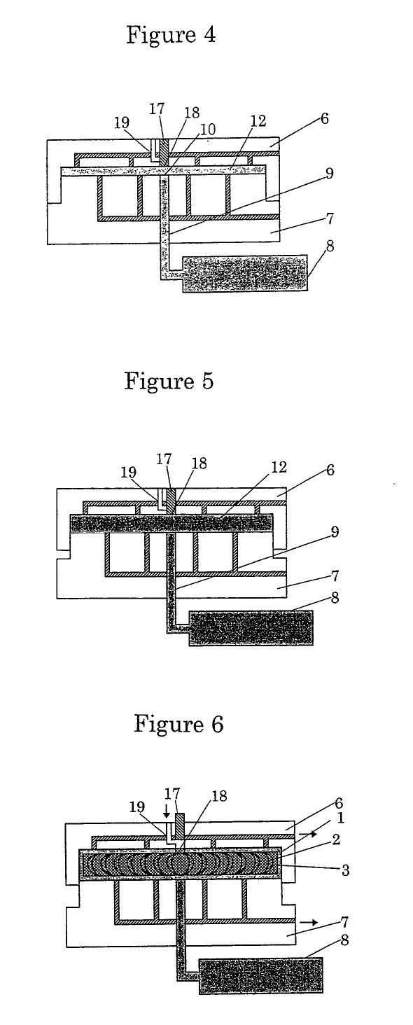

The former method by injection charging may be exemplified by a method in which the supply of a molten resin is commenced with both dies positioned so that the cavity clearance is less than the thickness of a molding before expansion (FIG. 4), the mold is opened concurrently with the supply of the molten resin, whereby the molten resin is charged in the cavity so that the cavity clearance becomes, at the same time when the supply of the molten resin is completed resin, equal to the thickness of the molding before expansion (FIG. 5), and a method in which the molten resin is supplied with both dies positioned so that the cavity clearance equal to the thickness of the molding before expansion is defined, whereby the molten resin is supplied and charged in the cavity.

In the former case by injection charging wherein the supply of the molten resin is commenced with the dies positioned so that the cavity clearance is less than the thickness of the molding before expansion, the cavity clearance defined at the time of the supply commencement ranges, in terms of a cavity volume, usually not less than 5% by volume and less than 100% by volume, preferably not less than 30% by volume and not greater than 70% by volume, based on the volume of a predetermined quantity of molten resin before expansion.

When the supply of the molten resin is commenced in such a state, the movable die retreats so that the cavity clearance is enlarged with the proceeding of the supply of the molten resin. On completing the supply of the molten resin of a predetermined quantity, the volume of the molten resin supplied becomes approximately equal to the capacity of the cavity and the molten resin is charged in the cavity.

In such a step, the enlargement of the cavity clearance may be controlled by the mechanical retreat of the die by using a press unit or the like associated with the mold. The cavity clearance may alternatively be enlarged by utilizing the supply pressure of the molten resin to be supplied. In any case, it is preferable that the enlargement is controlled so that the pressure applied to the resin would become about 1-50 MPa.

In the enlargement process of the cavity clearance, care must be taken that the cavity volume does not exceed the volume of the molten resin supplied. However, no special problem arises even when the cavity volume exceeds the volume of the molten resin supplied, if it occurs instantaneously or in a very short time.

Moreover, in the case of the injection charging, the method in which the supply of a molten resin is commenced with both dies positioned so that the cavity clearance is equal to the thickness of a molding before expansion only requires that the cavity clearance of the mold is maintained at the thickness of the molding before expansion from the beginning to the completion of the supply of the molten resin, as in the ordinary injection molding.

When the molten resin is charged in the cavity by the clamping of the dies, possible methods include one in which a predetermined quantity of molten resin is supplied into a mold cavity defined by both dies opened so that the cavity clearance is not smaller than the thickness of the molding before expansion (FIG. 8) and the dies are, after or at the same time as the supply is completed, closed so that the cavity clearance would coincide with the thickness of the molding before expansion, whereby the molten resin is charged (FIG. 9); and a method in which the supply of the molten resin is commenced during the clamping of the mold, the supply of the molten resin and the clamping of the mold are conducted in parallel so that the cavity clearance would become equal to the thickness of the molding before expansion just on or after the completion of the supply of the molten resin.

Of these methods, in the case of injection charging where the supply of the molten resin is commenced with the dies positioned so as to define a cavity clearance less than the thickness of the molding before expansion, the narrower the cavity clearance at the time of supplying the molten resin, the better the surface appearance of the moldings obtained. However, when the cavity clearance is too narrow, the damage to the reinforcing fibers in the molten resin tends to be great. Therefore, the cavity clearance is properly determined depending on the thickness, size and shape of the molding.

On the other hand, in the method in which the molten resin is charged by the clamping of the dies, since the pressure applied to the molten resin to be supplied becomes lower, the damage to the reinforcing fibers in the molten resin may be minimized, preventing the reduction of expandability or the reduction of strength.

Considering these facts, in general, the method by injection charging is useful when the external appearance of expanded moldings is important and the method by charging by the clamping of the mold is useful when expandability or strength is important.

In any method, to form a beam-supported structure more clearly, it is effective to impair the dispersibility of the reinforcing fibers or to conduct the operation of the injection of the molten resin intermittently with a very short period.

The molten resin charged in the mold cavity by such methods is in a state where it involves approximately no voids or, in some cases, have only slight voids.

A skin layer (1) is caused to form in such a state. Since the temperature of the mold is generally set to be lower than that of the molten resin, the molten resin begins to solidify from its surface portion in contact with a molding surface of the mold and a skin layer having approximately no voids or only slight voids is formed during an optional cooling time.

The cooling time has a great effect on the formation of a skin layer. The longer the cooling time, the easier the formation of a skin layer and the thicker a skin layer becomes.

The cooling time, that is, the time interval between the completion of the charging of the molten resin in the cavity and the opening of the mold in the next step may vary depending on various conditions such as the mold temperature, the temperature of the molten resin supplied and the type of the resin, and is generally about 0.2-20 seconds.

When the mold cavity is opened slightly in the thickness direction of the molding after the formation of a skin layer, the molten resin supplied, which is still in the unsolidified state, expands and a beam-supported structure layer (3) is formed (FIG. 6).

In this state, a continuous beam-supported structure is formed with the center at a resin supply opening in a multiple closed end form.

During such an operation of mold opening, it is desirable to control the mold opening speed, the mold opening stroke and the like with a press device mounted to the mold or a mold opening device installed in the mold, such as a hydraulic cylinder.

The mold opening speed has a great effect on the inclination angles of the reinforcing fibers to form the beam-supported structure layer or the multiple closed end state of the beams to be formed with the center at a resin supply opening. In the present invention, it is important to make the mold opening speed to be, for example, 0.1 mm/sec to 3 mm/sec, preferably 0.3 mm/sec to 2 mm/sec. When the mold opening speed is too great or too little, the beams forming the beam-supported structure layer may be obscure as aggregates or may be incompletely arcuate in view of the plane direction of the molding, or the angles between the reinforcing fibers and the skin layer may become improper.

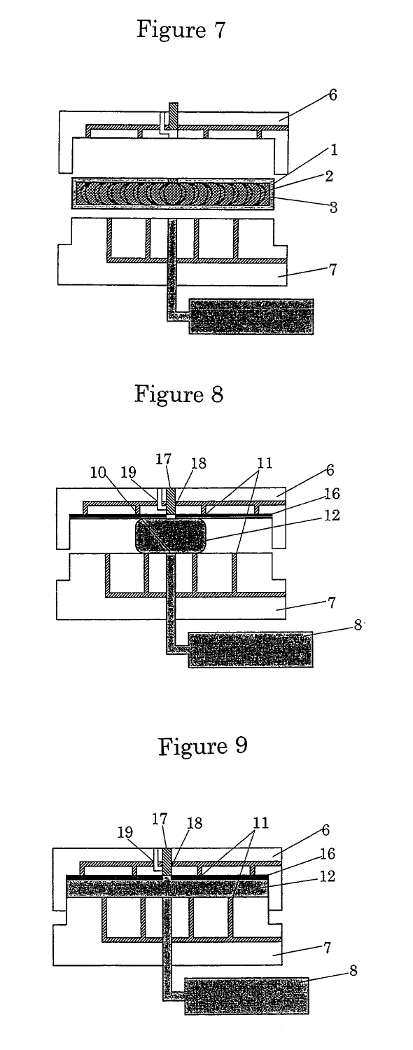

The mold is opened until the cavity clearance becomes a thickness of the desired final molding. After cooling the molding while holding the mold opened, the mold is opened completely and the molding is removed (FIG. 7).

Furthermore, in the aforementioned mold opening operation, it is also possible to open the mold so that the cavity clearance becomes greater than the thickness of the final molding, followed by re-compressing the molten resin by closing the mold until the cavity clearance becomes equal to the thickness of the final molding, while the molten resin does not solidify completely and at least the central portion of the resin is still in molten state.

In this case, it is possible to cause the molten resin supplied and the molding surface of the mold to more closely come into contact and also possible to reproduce the shape of the mold more faithfully.

In such a method, by using a mold having a plurality of resin supply openings, arcuate beam-supported structures are formed with centers at each resin supply opening.

Furthermore, in such a method, if the mold is opened in the thickness direction of the molding (FIG. 6) while the skin layer is attracted onto the molding surface of the mold by evacuating, in the course of or after the formation oI the skin layer, through a suction opening (11) provided in the mold, moldings having higher percentages of void may be obtained.

At this time, the mold is opened while taking the air into the molding by interconnecting the mold cavity with the atmosphere (FIG. 6). Due to that, the pressure inside the molding becomes negative and the inhibition of the restoring force of the reinforcing fibers is prevented, whereby a molding expanded with a high expansion ratio may be obtained.

In the above-described method, by using a mold having a structure where a part of the mold can be moved partly, a lightweight fiber-reinforced thermoplastic resin molding locally having an expanded portion may be produced.

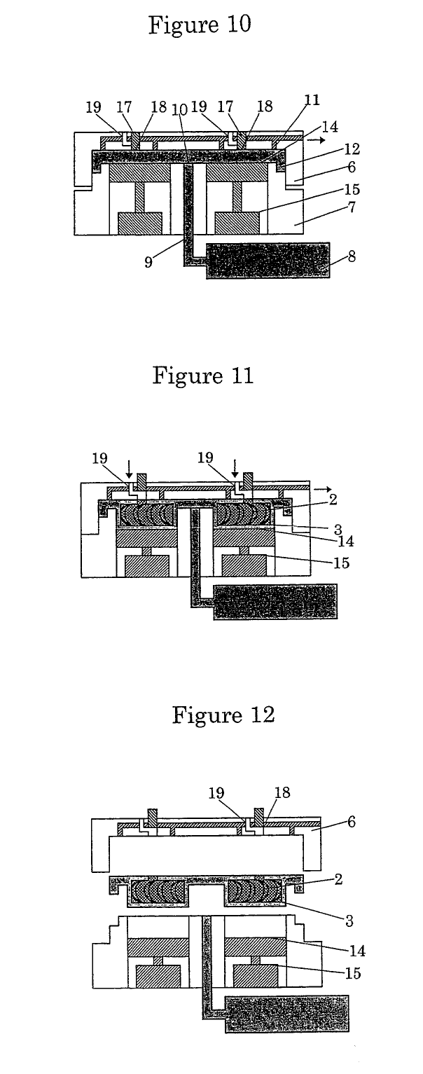

By using a mold, as shown in FIG. 10, in which a part of the mold is composed of a movable-molding-surface-forming member, for example a slide core system using a slide core (14), and a part of the molding surface of the mold can be locally and independently moved in the mold opening-and-closing direction through the movement of the slide core by a molding-surface-moving device such as a hydraulic cylinder (15) and adjusting the level of the molding surface of the slide core (14) to that of the molding surface of the mold, followed by charging a molten resin into the cavity by the aforementioned method, followed by locally opening the mold by retreating the slide core as shown in FIGS. 11-12, thereby expanding the opened portion of the molten resin, a lightweight fiber-reinforced thermoplastic resin molding may be obtained in which the portion where the slide core was located is locally expanded.

Moreover, in the case where what is required is a skin material-integrated lightweight fiber-reinforced thermoplastic resin molding, a part or the whole of the surface of which is covered with a skin material (16) laminated, the following operations may be conducted in the aforementioned method; placing, in advance, the skin material (16) on a molding surface of the mold so as to cover a part or the whole of the molding surface, supplying and charging a molten resin to between the skin material and the molding surface on which no skin material is placed according to the method mentioned above, and then opening the mold with evacuation as needed.

At this time, depending on the skin material, as shown in FIG. 8 and FIG. 9, the method in which the molten resin is supplied between the opened mold and charged into the cavity by the clamping of the dies is sometimes preferable.

As a skin material to be used in such a method, general skin materials may be employed such as sheets or films of various kinds of thermoplastic resins, foamed sheets of thermoplastic resins, non-woven fabrics, fabrics and combinations of these materials.

Furthermore, when a skin material is laminate, a skin layer may be difficult to be formed in the molten resin's surface on which the skin material is laminated. In such a case, it is also possible to use a skin material impermeable to gas and cause the skin material stuck with the molten resin to be attracted onto the molding surface of the mold by regarding the skin material as a skin layer.

The lightweight fiber-reinforced thermoplastic resin molding of the present invention may be produced by the above-described method, but, in some cases, only insufficient expansion occurs and insufficient voids are formed depending upon the type of the thermoplastic resin or reinforcing fibers to be used or the content of the reinforcing fibers. In such cases, expansion may be facilitated and the formation of voids may be compensated by use of a foaming agent,.

The amount of the foaming agent used here may be a slight amount as little as 0.01-5% by weight relative to the resin components contained in the raw material, the thermoplastic resin containing reinforcing fibers.

Moreover, the formation of voids may also be compensated by injection of a compressed gas into the molten resin through a gas injection opening or a resin supply opening provided in the molding surface of the mold.

The lightweight fiber-reinforced thermoplastic resin molding of the present invention has a high percentage of void and is lightweight and excellent in bending rigidity. Therefore, it can be widely used for various applications as various interior parts or structural parts.

What is claimed is:

1. A lightweight fiber-reinforced thermoplastic resin molding comprising a thermoplastic resin and having a skin layer and a beam-supported structure layer, the thermoplastic resin containing reinforcing fibers whose average fiber length is maintained at 1 mm or more, the skin layer having almost no voids, the beam-supported structure layer containing reinforcing fibers which are intertwined complicatedly with each other and are fixed to each other with the thermoplastic resin in the vicinity of their contacts, wherein the beams forming the beam-supported structure layer are arcuate as an aggregate in the plane direction of the molding.

2. The lightweight fiber-reinforced thermoplastic molding according to claim 1, wherein the reinforcing fibers constituting the beam-supported structure layer are oriented with leaning to the thickness direction of the molding and most of the reinforcing fibers make angles of 10-70 degrees to the skin layer.

3. The lightweight fiber-reinforced thermoplastic molding according to claim 1, wherein an average percentage of void in the skin layer and the beam-supported structure layer is 50 vol % or more.

4. The lightweight fiber-reinforced thermoplastic molding according to claim 1, wherein a skin material is laminated on at least a part of the surface of the molding.
